(19) United States
(12) Patent Application Publication
(10) Pub. No.: US 2024/0257997 A1
(43) Pub. Date: Aug. 1, 2024

(54) CABLE ALIGNMENT APPARATUS AND METHOD FOR ALIGNING ASSEMBLED CABLE ENDS OF TWO CABLES OF A CABLE HARNESS IN THE CORRECT ROTATIONAL POSITION

(71) Applicant: Komax Holding AG, Dierikon (CH)

(72) Inventor: Pietro Fiorentino, Ebikon (CH)

(21) Appl. No.: 18/420,851

(22) Filed: Jan. 24, 2024

(30) Foreign Application Priority Data
Jan. 30, 2023 (EP) 23153941.2

(51) Int. Cl. H01B 13/04; H01B 13/02

(52) U.S. Cl. CPC H01B 13/04; H01B 13/0207

(57) ABSTRACT

A dual cable alignment apparatus aligns assembled cable ends provided with contact elements on two cables of a twisted cable strand in a predetermined correct rotational position. The alignment apparatus includes two cable rotating modules arranged on an apparatus frame and equipped with rotary cable grippers for rotating each assembled cable end about its longitudinal axis, and an optical detection apparatus for determining the corresponding rotational position of the assembled cable ends. To adjust the distance between the assembled cable ends, a cable rotating module is displaceable by a drive on the apparatus frame, whereby it is ensured that each assembled cable end can be brought into the desired rotational position precisely and reliably, and an optimal shadow image of the two contact elements can be detected for position detection.

### FIELD

The invention relates to a cable alignment apparatus for aligning assembled cable ends of two cables of a cable strand in a predetermined correct rotational position. Furthermore, the invention relates to a method for aligning assembled cable ends in the predetermined correct rotational position.

### BACKGROUND

Cable harnesses, such as those used in automobiles or aircraft, consist of several cables, which are provided with plug housings at their prefabricated cable ends. For this purpose, the prefabricated cable ends, i.e., the cable ends that are cut to length, stripped and provided with contact elements (for example crimp contacts), are inserted into chambers or receivers of the plug housing. As a rule, the cables of a cable harness with the cable ends to be assembled are present individually and are also individually introduced into the chambers of the plug housing by means of corresponding mechanical devices. More and more cable harnesses consist of two or several cable strands made from a plurality of cables, mainly twisted cables, for which there is also a need to assemble the free, in particular untwisted, and optionally elongated cable ends of the cable harness. Twisted cables, such as so-called UTP (Unshielded Twisted Pair) cables, provide greater protection against electrical and magnetic interference compared to untwisted conductor pairs, and are characterized by particularly good signal transmission quality. In addition to twisted cables, untwisted cables of cable strands or other multi-cable systems, in which the cables are only arranged side by side and combined in a group, can be used as well.

Corresponding mechanical devices known to the person skilled in the art as cable assembling stations are used for the automatic assembling of plug housings with cable strands consisting of two cables. The two contact elements must be in the correct rotational position (angular position around the longitudinal cable axis) to fit and be inserted into cells of a plug housing, which makes automatic assembling of plug housings with cables challenging. In order to take advantage of UTP cables, the untwisted areas of the cable ends should be as short as possible. The alignment of such short cable ends of the twisted pair in the correct rotational position is particularly demanding.

A cable alignment apparatus for aligning assembled cable ends of two cables of a twisted cable strand in the correct rotational position has become known from EP 3 301 768 A1. In this cable alignment apparatus, the cable ends can be rotated by means of a rotary gripping apparatus that applies pressure to the cable strand at the twisted cable area. An optical detection apparatus for determining the rotational position of the cables checks the alignment of the contact elements (this method step is also referred to below as “testing” for short). Such an optical detection apparatus has already been described in EP 1 304 773 A1. The cable alignment apparatus in accordance with EP 3 301 768 A1 further comprises cable grippers arranged one behind the other at the portion of the untwisted cable end in the longitudinal direction of the longitudinal axis. The cable grippers are set up to fix only one cable at a time at the cable end and to guide the cable end of the other cable. If one cable end is in the correct rotational position by turning the cable strand at the twisted cable area, it is fixed by the relevant cable gripper, while the other cable end is only guided by the cable gripper. Once both contact elements are correctly oriented, the actual assembling process can begin. The orientation process of this cable alignment apparatus is evidently performed in several steps.

### SUMMARY

It is therefore an object of the present invention to avoid the disadvantages of what is known and, in particular, to provide an improved or alternative cable alignment apparatus for aligning assembled cable ends of two cables of a twisted cable strand in the correct rotational position, which apparatus can be operated in particular efficiently.

This object is solved according to the invention by means of a cable alignment apparatus for aligning assembled cable ends of two cables of a cable strand, in particular a twisted cable strand, in the correct rotational position. This cable alignment apparatus is also referred to below as a dual cable alignment apparatus for the sake of simplicity. The dual cable alignment apparatus comprises two cable rotating modules, preferably arranged on an apparatus rack, for rotating an assembled cable end about its longitudinal axis, wherein each cable rotating module has a rotary cable gripper and a rotating apparatus for rotating the rotary cable gripper for the desired rotation of the cable end about its longitudinal axis in order to change the rotational position. The term “rotary cable gripper” is understood to mean cable grippers which can rotate the cables about their longitudinal axis by means of the mentioned rotating apparatus. The rotary cable grippers can have two gripper jaws that can be moved toward one another for holding fast the corresponding cable end by clamping. The dual cable alignment apparatus can therefore comprise an apparatus frame for supporting the cable rotating modules and also a preferably optical detection apparatus for ascertaining the rotational position of the cable ends. The dual cable alignment apparatus is characterized by the fact that, to adjust the distance between the assembled cable ends, at least one cable rotating module is arranged on the apparatus frame so that it can be moved as a whole by means of a drive. Furthermore, control means can be provided for actuating the drive for precise adjustment of the distance between the assembled cable ends. Adjusting the distance between the assembled cable ends as required results in an advantageous offset, thanks to which the rotational position of the cable ends can be easily ascertained, preferably by means of the mentioned optical detection apparatus. The mentioned rotational position can be determined by an angle about the cable longitudinal axis (cable axis for short). The angle indicates by how much the cable would have to be rotated around its longitudinal axis, or cable axis, from its actual position to reach its target position. The mentioned offset relates to the position of the cable axes. The relative position of the cable axes can be changed by the offsetting. The rotary cable grippers can ensure that each cable is precisely and reliably brought into the desired rotational position. With the dual cable alignment apparatus, assembled cable ends can be aligned efficiently and quickly. This also creates the basis for the cable ends with the contact elements to be easily inserted into cells of a plug housing. The rotary cable grippers make it possible to align both cables or cable ends at the same time, which significantly reduces the process time for alignment in the correct rotational position.

The dual cable alignment apparatus can comprise an optical detection apparatus for determining the rotational position of each of the assembled cable ends. Preferably, the rotational positions of the cable ends are determined at least before the start of the alignment procedure. Based on the knowledge of the actual condition, it is possible to calculate to what extent the cable must be rotated. Preferably, after the first adjustment of the rotary cable grippers, it is checked whether the rotational position has actually assumed the target position. Otherwise, the readjustment procedure must be repeated again. For example, the optical detection apparatus may comprise a camera. The optical detection apparatus may alternatively be or comprise a scanning unit or image capture module with at least one line sensor. The assembled cable ends are preferably inserted into the image acquisition module before the alignment procedure begins. The image acquisition module can comprise two line sensors arranged in different directions, wherein the assembled cable ends can be introduced into the image acquisition module before or at the beginning of the alignment process.

At least one of the cable rotating modules can be displaceable in the vertical direction for adjusting the vertical distance between the cable ends. The dual cable alignment apparatus can be designed in such a way that, in the operationally ready state, the cable strand and the assembled cable ends to be aligned run in the horizontal direction. Of course, other displacement directions are also conceivable as an alternative to the vertical direction. For example, the displaceable cable rotating module could be installed obliquely in the cable alignment apparatus and enable a movement in the diagonal direction to create the offset. A diagonal direction is understood to mean an oblique, i.e., non-vertical, displacement direction, wherein the displacement direction can preferably be inclined by 45° to the horizontal.

The cable alignment apparatus can have two cable rotating modules arranged displaceably on the apparatus frame. However, for cost reasons, it can be advantageous if only one cable rotating module is arranged so as to be displaceable on the apparatus frame and that the other cable rotating module is arranged in a stationary manner on the apparatus frame.

Furthermore, it can be advantageous if the cable rotating modules are arranged one behind the other in relation to a longitudinal direction, which generally coincides with the cable axis. This arrangement one behind the other can in particular relate to the cable grippers of the cable rotating modules. The drives for rotating the cable grippers do not have to be arranged one behind the other, but can for example be arranged side by side.

The cable alignment apparatus can have a linear drive for displacing the cable rotating module. For example, pneumatically operating linear drives or other linear drives can be used as the actuator for displacing the cable rotating module. The linear drive can contain an electromechanical linear drive or also a threaded spindle.

Preferably, a pneumatic cylinder can be integrated into the apparatus frame as a drive for displacing the cable rotating module. Pneumatic drives are cost effective and easy to handle with respect to control.

The rotary apparatuses for rotating the rotary cable grippers for changing the rotational position of the cable ends can comprise drives which are connected to the rotary cable grippers in terms of transmission via pinions and toothed ring segments. With such an arrangement, the desired rotational position of the corresponding cable end can be achieved easily and precisely. The toothed ring segment can be provided with an internal toothing or external toothing, which is in operative connection with a pinion that is in engagement with it and can be driven by means of a motor.

The corresponding rotary cable gripper can be attached to a toothed ring segment which defines a limited rotational range of at most 90° and preferably between 30° and 45°. In this way, further costs can be saved and the rotary apparatuses can be obtained in a compact design. The rotary cable gripper can be rigidly connected to the toothed ring segment. Of course, other types of fastening are also conceivable.

A further aspect of the invention can relate to an arrangement for handling cables, having a cable alignment apparatus for aligning assembled cable ends of two cables of a cable strand, in particular a twisted cable strand, in the correct rotational position, in particular the dual cable alignment apparatus described above, and having an assembly gripping unit with two individually controllable assembly cable grippers for gripping the assembled cable ends of the cables, which are aligned in the correct rotational position, and for feeding the assembled cable ends to plug housings. Assembling can be done exemplarily in a plug housing with two cells. However, two plug housings are also conceivable, into each of which the respective cable ends are inserted.

The invention further relates to a method for aligning assembled cable ends of two cables of an in particular twisted cable strand in a rotationally correct manner, preferably using the previously described cable alignment apparatus and, if appropriate, for equipping plug housings with assembled cable ends of two cables of the in particular twisted cable strand. The method is characterized in that the rotational position of the assembled, preferably horizontal cable ends of the cables extending along cable axes is changed by means of the cable alignment apparatus and in this way the corresponding assembled cable end is aligned, wherein the preferably horizontal cable ends for creating an offset at the beginning of the alignment process are brought to different heights in relation to their cable axes by means of the cable alignment apparatus. This results in an advantageous height offset of the cable ends, thanks to which the rotational position of the cable ends can be easily determined, preferably by means of an optical detection apparatus. If the cables have, according to a preferred embodiment, a horizontal course, then the height of the respective cable ends would correspond to the vertical distance from a horizontal reference surface, for example a reference surface defined by a machine table or the floor. In order to bring the cable ends to different heights, at least one of the cables can be moved parallel to the axis. The mentioned offset, or more precisely height offset, can be understood as the vertical distance between the cable ends created in this way. However, there can also be cases in which creation of the offset by means of the cable alignment apparatus does not take place. If, for example, the cables to be aligned have contact elements with a flat cross-section that are to be aligned horizontally, the test is carried out with the offset from the start.

The cable ends can be brought to different heights to create an initial offset using the assembly gripper unit before the alignment process begins. It is therefore conceivable that, as an alternative or possibly in addition to creating an offset using the cable alignment apparatus, the cable ends are brought to different heights to create an initial offset using the assembly gripper unit, which process takes place before the start of the alignment process. The initial offset is created before the cables are gripped for the first time by the cable grippers or other means of application of the cable alignment apparatus or are otherwise acted on. This can be necessary in particular in the case of contact elements with a flat cross-section that are to be aligned horizontally.

To create an offset at the beginning of the alignment process, the cable ends can be moved relative to one another by a predetermined or a variable displacement path. An offset may be necessary if it has been recognized that the cable ends, or for example, more precisely, the contact elements at the cable ends, are in unfavorable positions, making it difficult to detect the rotational position of the cable ends using a detection apparatus. The offset only needs to be created if required. A predetermined fixed displacement path, which can for example be a few millimeters, can be implemented particularly easily. If the contact elements are positioned and oriented favorably, the aforementioned requirement is not present and the offset is not created.

If an initial offset is necessary before the start of the alignment process, the corresponding relative movement of the cable ends preferably takes place by a predetermined fixed displacement path.

It can be advantageous if the rotary cable gripper(s) of the cable alignment apparatus is/are moved in a vertical direction to create the offset. Alternatively, other directions of movement for moving the rotary cable grippers are also conceivable. For example, at least one of the rotary cable grippers can be displaced in a diagonal direction to create the offset. A diagonal direction is understood to mean an oblique, i.e., non-vertical, displacement direction, where the displacement direction is preferably inclined by 45° relative to the horizontal.

In order to create the offset at the beginning of the alignment process, only one of the cable ends can be moved while the other cable end remains stationary. For certain applications, however, it can be advantageous if both cable ends are moved to create the offset.

It can be particularly advantageous if the cable ends are moved away from one another or toward one another in a diagonal direction until the cable ends are positioned one above the other in the vertical direction.

The rotational position of the assembled cable ends can be monitored by means of an optical detection apparatus that uses a shadow image of the contact elements to detect the position. The shadow image is preferably generated from the shadow width or shadow contour of the contact elements and the angle of rotation of a scanning unit of the optical detection apparatus.

A particularly advantageous method is obtained when the rotational position of the assembled cable ends is monitored by means of the optical detection apparatus, which uses a shadow image of the two contact elements of the cable ends for position detection, wherein, when determining the rotational position of the assembled cable ends, the area of the shadow image in which an overlap of the shadow contours of the two contact elements occurs distorts the shadow image due to the mentioned offset, and in this way the image acquisition is optimized. Thanks to the improved shadow image obtained by this distortion, the rotational position of the assembled cable ends can now be determined easily and precisely.

Before or at the beginning of the alignment process, the rotational position of the assembled cable ends can be determined by means of the optical detection apparatus, wherein the optical detection apparatus uses a shadow image of the two contact elements of the cable ends for position detection (actual state) and that, on the basis of the knowledge of the actual state, it can be calculated to what extent the cable end has to be rotated.

The determination of the rotational position of the assembled cable ends by means of the optical detection apparatus can in particular also be carried out after the initial offset has been created by means of the assembly gripping unit and/or after the offset has been created by means of the cable alignment apparatus.

To determine the rotational position of the assembled cable ends, an optical detection apparatus with two light curtains and associated line sensors can be used, wherein the two light curtains and correspondingly the line sensors are oriented at right angles to each other, wherein one of the light curtains is a preferably vertically oriented light curtain and the other light curtain is a preferably horizontally oriented light curtain.

For rotating the assembled cable ends in order to change the rotational position, rotary cable grippers, which are each attached to toothed ring segments which define limited ranges of rotation, can be used. If the current rotational position of one or both assembled cable ends exceeds a certain angular range, it can be advantageous if the relevant rotary cable gripper(s) is/are moved to an initial position removed from the neutral position specified by the toothed ring segment before the alignment process begins.

The finally aligned assembled cable ends can be subjected to a rotary position end test while the cable ends are still held by rotary cable grippers (of the cable alignment apparatus) or after they have been gripped by the assembly gripping unit.

Furthermore, it can be advantageous if the assembled cable ends are pre-aligned and only then the rotational position of the assembled cable ends is determined for the first time by means of the optical detection apparatus. The process time for performing the alignment procedure can thus be reduced even further. For example, an operator can perform the pre-alignment manually.

### DESCRIPTION OF THE DRAWINGS

Further individual features and advantages of the invention can be derived from the following description of exemplary embodiments and from the drawings. In the drawings:

FIG. 1 shows a perspective view of a dual cable alignment apparatus according to the invention for aligning the assembled cable ends of two cables of a twisted cable strand in the correct rotational position,

FIG. 2 is a perspective view of an arrangement with the dual cable alignment apparatus according to FIG. 1, an optical detection apparatus, and an assembly gripping unit,

FIG. 3a shows a side view of the dual cable alignment apparatus of FIG. 1,

FIG. 3b shows a front view of the dual cable alignment apparatus,

FIGS. 4a, 4b show a side view and a front view of the dual cable alignment apparatus after a cable rotating module has been displaced in the vertical direction,

FIG. 5a shows a perspective view of the cable alignment apparatus,

FIG. 5b shows the cable alignment apparatus after an alignment process or with rotated cable rotating modules,

FIG. 6a shows the cable alignment apparatus according to FIG. 5a, but with a vertically displaced cable rotating module, a simplified representation of the test situation with a shadow image when a contact element is rotated,

FIG. 6b shows the cable alignment apparatus with rotated cable rotating modules according to FIG. 5b, but with a vertically displaced cable rotating module,

FIG. 7 shows a simplified representation of a test situation for determining the rotational position of assembled cable ends with a shadow image, wherein the cable ends have contact elements which are to be aligned with their narrower side in the vertical direction,

FIG. 8a shows a simplified representation of a test situation for determining the rotational position of assembled cable ends with a shadow image, wherein the cable ends have contact elements which are to be aligned with their narrower side in the horizontal direction,

FIG. 8b shows the test situation with shadow image according to FIG. 8a, wherein, however, one of the contact elements has been displaced upwards,

FIGS. 9a, 9b show a diagram of a shadow curve of contact parts to be aligned with their narrower side in the horizontal direction (FIG. 9a), wherein one cable end is displaced upwards and the other is displaced downwards (FIG. 9b), and

FIGS. 10a, 10b show a diagram of a shadow curve of contact parts which are to be aligned with their narrower side in the horizontal direction (FIG. 10a), wherein the cable ends are displaced diagonally until the cable axes are positioned vertically one above the other (FIG. 10b).

### DETAILED DESCRIPTION

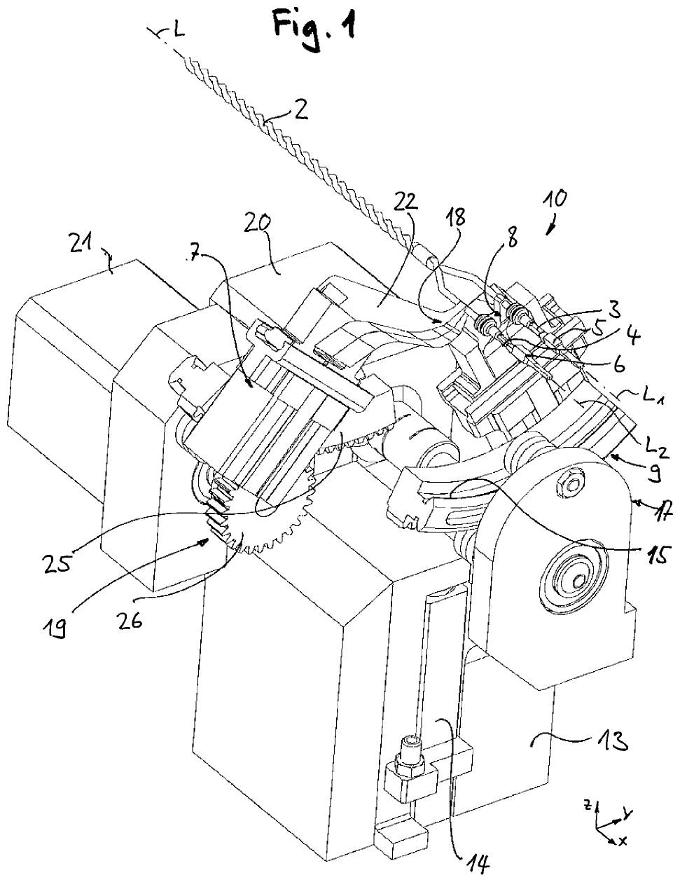

FIG. 1 shows a cable alignment apparatus 10 for aligning the cable ends 3, 4 of two cables of a twisted cable strand 2 extending along a longitudinal axis L in the predetermined correct rotational position. Therefore, for simplicity, the term “dual cable alignment apparatus” is also used below for the cable alignment apparatus 10 handling two cables. The respective cable is usually an electrical cable containing, for example, a solid conductor made of copper or aluminum or stranded wire and insulation as a sheath for the conductors.

The Cartesian coordinate system shown in FIG. 1 is used to assist in understanding the directions and major motions of the components of the dual cable alignment apparatus 10. The dual cable alignment apparatus 10 comprises two cable rotating modules 7, 17 arranged on an apparatus frame 13. Each of the cable rotating modules 7, 17 is here assigned to one of the cables of the cable strand 2. The cable rotating modules 7, 17 are each used to rotate an assembled cable end 3, 4 about its longitudinal axis L1, L2. Each cable rotating module 7, 17 has a rotary cable gripper 8, 18 and a rotating apparatus 9, 19 for rotating the rotary cable gripper 8, 18 for the desired rotation of the cable end about its longitudinal axis to change the rotational position. The mentioned longitudinal axes L1, L2 are also referred to below as “cable axes” for the sake of simplicity.

To adjust the distance between the assembled cable ends, which in this example run horizontally, the cable rotating module designated 7 is arranged on the apparatus frame 13 so that it can be displaced by means of a drive 14. Furthermore, control means (not shown) can be provided for actuating the drive for precise adjustment of the distance between the assembled cable ends. Adjusting the distance results in an advantageous offset, explained in detail below, which makes it possible to change the position of the contact elements of the assembled cable ends relative to each other, which can simplify difficult test situations.

The rotary cable grippers 8, 18 each have two gripper jaws 22 that can be moved towards each other for clamping the respective cable end 3, 4. The gripper jaws 22 are mounted on linear guides and can be opened and closed by means of feed drives.

In the present exemplary embodiment, the cable rotating module 7 is displaceable in the vertical direction z for adjusting the vertical distance between the horizontal cable ends. The other cable rotation module 17 is arranged in a stationary manner on the apparatus frame 13. A pneumatic cylinder 14 is integrated in the apparatus frame 13 as a drive for displacing the cable rotation module 7.

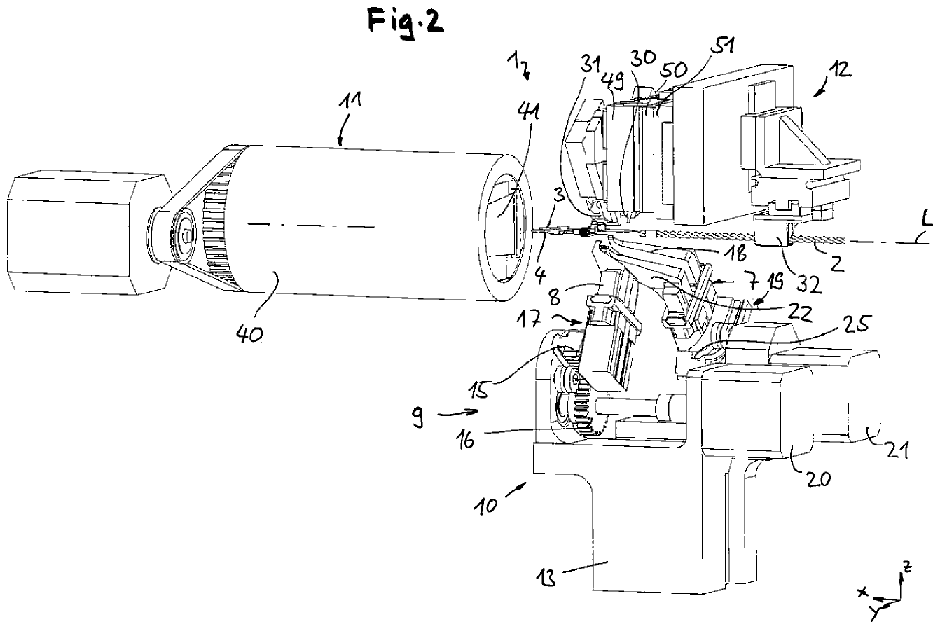

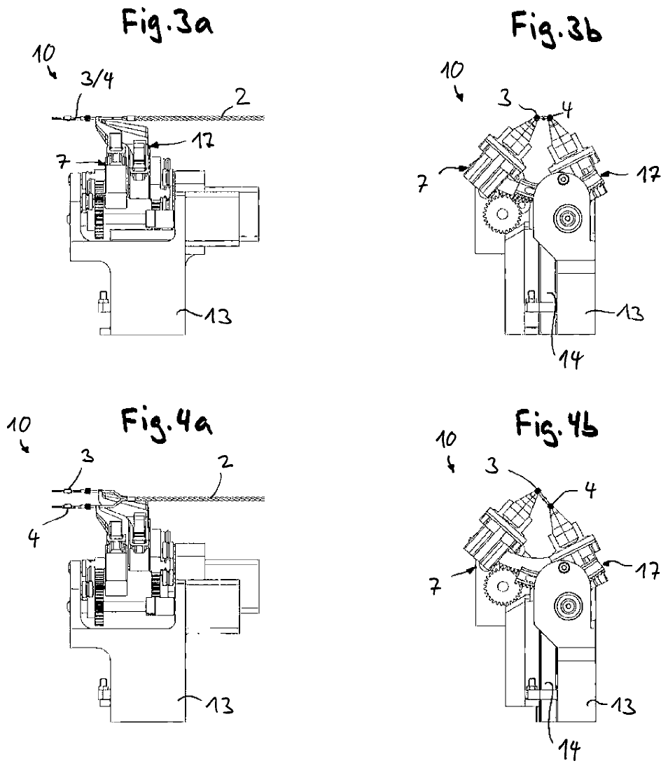

The rotating apparatuses 9, 19 for rotating the rotary cable grippers 8, 18 to change the rotational position of the cable ends comprise drives 20, 21 which are connected in terms of transmission to the rotary cable grippers 8, 18 by means of pinions 16 (FIG. 2), 26 and toothed ring segments 15, 25. The corresponding rotary cable gripper 8, 18 is attached to a toothed ring segment 15, 25 with an external toothing, which defines a limited rotational range. In the first embodiment shown here by way of example, the cable alignment apparatus 10 has two independent rotary cable grippers 8, 18, which can each be rotated by ±17.5° about the respective cable axis. The two cable axes L1, L2 run parallel at a distance of 10 mm and are positioned offset by 6 mm in the negative z-direction to the axis of rotation of the test head 40 (FIG. 2).

The cable alignment apparatus 10 shown here is used in particular with regard to the subsequent assembling of plug housings with assembled cable ends. In this example, crimp contacts are attached as contact elements 5, 6 to the respective stripped cable ends of the twisted cable strand 2.

As can be seen from FIG. 1, the assembled cable ends 3, 4 of the cables are not aligned and are skewed with respect to the vertical and horizontal. The dual cable alignment apparatus 10 described in detail below can be used to align the cable ends 3, 4 in the correct rotational position.

The twisted cable strand 2 can be a so-called UTP cable. Contact elements 5, 6 with rectangular or diamond-shaped outer contours in cross-section are attached to the free cable ends 3, 4. However, the contact elements 5, 6 could also have other shapes that are non-circular in cross-section. Round contact elements usually do not require alignment of their rotational position. Furthermore, grommets can be attached to the cable ends 3, 4. Of course, grommets can also be dispensed with as required. The short, untwisted area with the assembled cable ends 3, 4 adjoins this twisted area at the front. However, the dual cable alignment apparatus 10 can also be used to process untwisted cable strands composed of two cables or also both ends of a single cable.

To check whether the assembled cable ends of cables 3, 4—more precisely, the contact elements 5, 6 of the cable ends 3, 4—are in the correct rotational position after the alignment procedure, the optical detection apparatus 11 shown in FIG. 2 can be used. However, this optical detection apparatus 11 can also be used to determine the actual states of the cable ends, i.e., the misalignments which are substantially characterized by the angles, before or at the beginning of the alignment procedure. The optical detection apparatus 11 comprises an image acquisition module having a scanning unit with line sensors. The optical detection apparatus 11 further comprises a cylindrical test head 40, exemplified here, which contains the line sensors and which can be rotated around its axis in a manner known per se. For this purpose, for example, an image capture module can be used, as has already become known from EP 1 304 773 A1. For details on the structure and the basic mode of operation, please refer to this document. The present optical detection apparatus 11 differs from the known detection apparatus primarily in that it is particularly well suited for detecting assembled cable ends of two cables. This aspect will be discussed in detail below, in particular with reference to FIGS. 7 to 10b.

After the angular position has been set by rotating the rotary cable grippers 8, 18, the rotational position of the assembled cable end 3, 4 is checked for each cable using the optical detection apparatus 11 to determine whether the target position has actually been adopted. Otherwise, the readjustment procedure must be repeated again.

After completion of the alignment procedure, in which the assembled cable ends of the two cables 3, 4 were aligned in the correct rotational position by means of the dual cable alignment apparatus 10 described above, and the alignment of the assembled cable ends in the correct rotational position is determined or checked by means of the optical detection apparatus 11, the actual assembling can be carried out as the next work step. For the assembling, the assembled cable ends of the cables 3, 4 are gripped by an assembly gripping unit 12 and guided to plug housings (not shown), which is shown in FIG. 2. For example, the contact elements 5, 6 are inserted into cells of a plug housing.

The dual cable alignment apparatus 10 is thus, in the present case, a component of an arrangement for handling cables, designated 1, which will be referred to hereinafter as the “assembly arrangement” for the sake of simplicity. The assembly arrangement 1 comprises the dual cable alignment apparatus 10, the optical detection apparatus 11, and the assembly gripping unit 12.

The assembly gripping unit 12 has two cable grippers 30, 31 for gripping the assembled cable ends 3, 4 of the cables and for feeding the assembled cable ends, which have been aligned in the correct rotational position, to plug housings. Each of the cable grippers 30, 31 can be controlled individually and can each be moved in the x, y and z directions. The fact that the cable grippers 30, 31 can be moved independently of one another by means of corresponding actuators ensures that the cables, which are usually at different heights after the alignment procedure, can be gripped. A third gripper 32 is also provided for strain relief of the cable strand 2 during assembling. By means of actuators designated as 50, the assembly cable grippers 30, 31 can be moved up and down in the z direction in order to be able to grip the cables located at different heights. Actuators 49 are used to move the assembly cable grippers 30, 31 in the x direction; actuators 51 are used to move the assembly cable grippers 30, 31 in the y direction.

The assembly cable grippers 30, 31 grip the cables in the area of the cable ends 3, 4, in each case in front of the rotary cable grippers 8, 18 that act on the cables. In particular, the rotary cable gripper designated 18 has a strongly cranked shape.

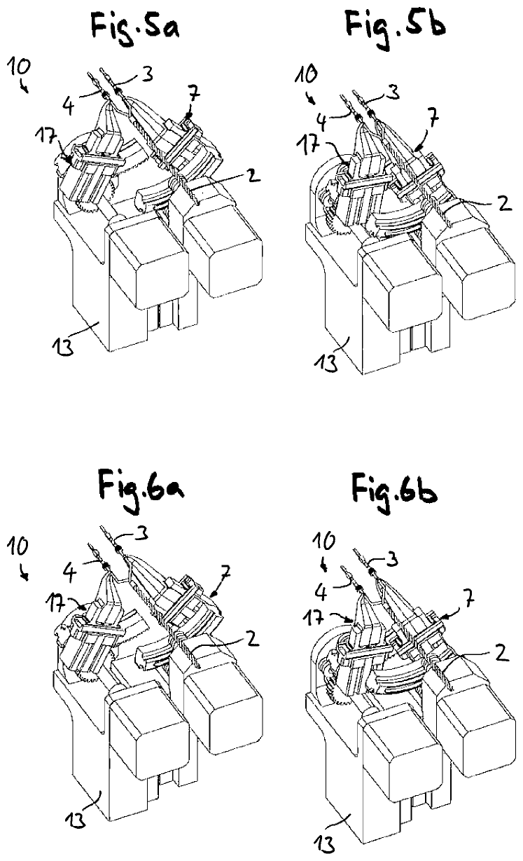

FIG. 3a shows a side view and FIG. 3B shows a front view of the dual cable alignment apparatus 10 of FIG. 1. FIGS. 4a, 4b show a side view and a front view of the dual cable alignment apparatus 10 after a cable rotating module 7 has been displaced in the vertical direction. FIG. 5a shows a perspective view of the cable alignment apparatus 10 and FIG. 5b shows the cable alignment apparatus after an alignment process or with rotated cable rotating modules 7, 17. FIG. 6a shows the cable alignment apparatus 10 according to FIG. 5a, but with a vertically displaced cable rotating module 7, a simplified representation of the test situation with a shadow image when a contact element is rotated. FIG. 6b shows the cable alignment apparatus 10 with rotated cable rotating modules according to FIG. 5b, but with a vertically displaced cable rotating module 7.

The rotational position of the assembled cable ends is monitored by means of an optical detection apparatus 11, which uses a shadow image of the two contact elements 5, 6 of the cable ends 3, 4 to detect the position. FIG. 7 shows an example of a test situation with a shadow image.

The optical detection apparatus 11 contains at least one light curtain 41 with an oppositely situated sensor. After the optical detection apparatus 11 has been moved into a test position, the optical detection apparatus 11 rotates the test head 40 around the contact elements 5, 6 and checks the rotational position of the contact elements. The test head 40 has the light curtain 41 and the associated line sensor for generating shadow images of the contact elements 5, 6. As the test head 40 rotates around the contact elements 5, 6, the captured shadow images are recorded.

In the present embodiment, however, the optical detection apparatus 11 has two light curtains with associated line sensors, wherein the two light curtains and accordingly the line sensors are oriented at right angles to one another. In the present case, one of the light curtains is a vertically oriented light curtain and the other light curtain is a horizontally oriented light curtain (see FIG. 7). As the test head rotates around the contact elements 5, 6, the captured shadow images are recorded. The shadow edges 45 of the contact elements are illuminated in this manner.

The method for aligning the assembled cable ends of two cables of the UTP cable in the correct rotational position can run as follows, for example: The finally processed UTP cable is inserted into the cable alignment apparatus 10 and the cables are gripped at the untwisted cable ends by the cable rotation modules 7, 17. For strain relief, the twisted area of the cable can be held by the gripper 32 at a certain distance from the cable alignment apparatus 10. The optical detection apparatus 11 is then moved into a test position. There, the optical detection apparatus 11 rotates the test head 40 around the contact elements 5, 6 and checks the rotational position of the contact elements. The test head 40 has at least the one light curtain 41 and the associated line sensor 42 to generate shadow images of the contact elements 5, 6. As the test head 40 rotates around the contact elements 5, 6, the captured shadow images are recorded.

As can be seen in FIG. 7, the optical detection apparatus 11 comprises a first light curtain 41 and a first line sensor 42 situated opposite it. Between them are the assembled cable ends of the two cables, wherein the contact elements 5 and 6 are shown simplified as almost rectangular cross-sectional areas. In the present exemplary embodiment, the contact elements 5 and 6 have a rectangular outer contour. As can be seen, the rectangles are not perpendicular to the light curtain 41, which is close to a real situation in which the cable ends may be slightly tilted. The optical detection apparatus 11 is rotatable around an axis of rotation extending in the direction of the x axis. The line sensor 42 captures an image after each rotation by a small angular distance of the optical detection apparatus 11, resulting in the composite shadow image shown on the right in FIG. 7.

The axis of the shadow image, denoted by ω, corresponds to the angle of rotation of the optical detection apparatus 11. The optical detection apparatus 11 comprises a second light curtain 43 and a second line sensor 44 situated opposite thereto. Data from the arrangement with the second light curtain 43 and associated line sensor 44 can also be used to determine the rotational position of the assembled cable ends.

In a manner known per se, the shadow contour is examined for local minima 46 in order to determine the rotational position of the contact elements 5, 6. However, since there are two contact elements 5, 6, the two shadow contours 45 overlap when the test head 40 rotates around the contact elements 5, 6. In the overlap area designated 47, an angular range test is difficult, i.e., the angular rotation area of the test head 40 in which it is expected that the contact elements 5, 6 lie one above the other (from the point of view of the line sensor 42). The areas 55 and 56 show the corresponding test area of the sensors when the test head makes only one rotation between the angular positions −40° and +40°. In FIG. 7, the line sensor 44 finds the minima of the contact parts 5, 6 in its measuring range 56. The line sensor 42, on the other hand, does not find the minima, as the contacts in its measuring range 55 overlap precisely there.

If the contact elements 5, 6 extend approximately parallel to the axis of rotation of the test head 40 and have a rectangular cross-section in the sectional plane of the light curtain 41, then the minima 46 of a contact element 5, 6 are offset from one another by 90°. In this ideal situation, the local minima repeat after 180°. Therefore, it is not necessary to search the whole area of 360° for the minima. If the contact elements 5, 6 with rectangular cross-section extend at a small angular amount (e.g. 5°) to the axis of rotation of the test head 40, the acquired cross-section may be distorted a little to a parallelogram if the tilting axis is diagonal.

As long as the minima 46 do not move too far away from 90°, this case can be compensated by the tolerance range of the cable alignment apparatus 10.

If the cross section of the rectangular contact element is strongly distorted to a parallelogram, the current rotation position can also be calculated. The subsequent assembling process could possibly be impeded by a bent cable tip and the preceding machining process therefore has a defect. Therefore, an error message is often preferred.

To shorten the test time, it is also conceivable that the test head 40 includes a second light curtain 43 with associated line sensor 44, wherein this second light curtain is positioned offset by 90° to the first light curtain 41.

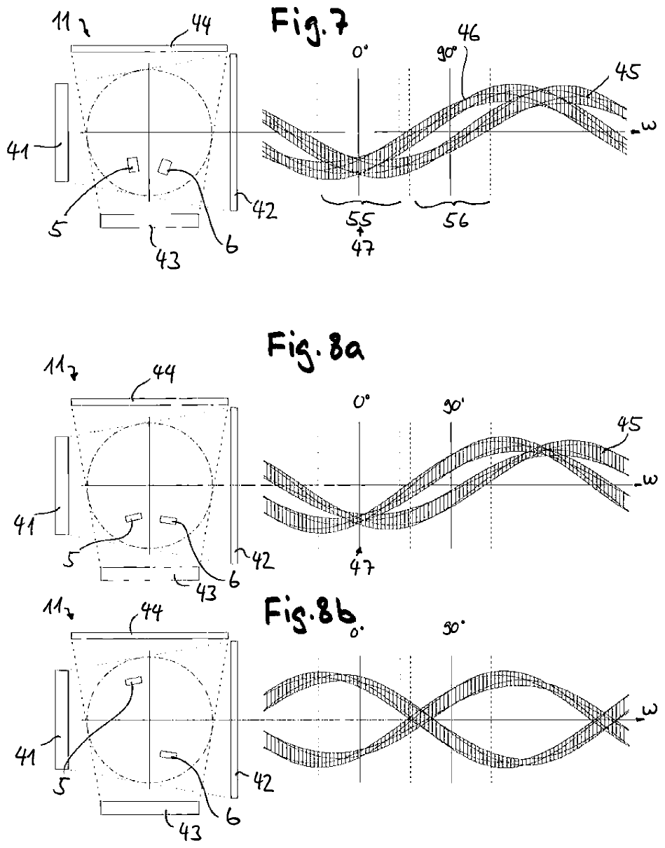

FIG. 8a shows, at the left, a situation in which contact elements 5, 6 are to be aligned with their narrower side in the horizontal direction. For this situation, the measurement of the vertical sensor designated 42 is evaluated. This results in the shadow image shown on the right in FIG. 8a. The area of overlap 47 of the expected overlap is difficult to test. To overcome this difficulty, the contact element 5 is moved into the position shown in FIG. 8b by moving the corresponding cable rotating module. If, as in the present case, the contact elements have the contour of a flat rectangle, which are to be aligned horizontally, the position of contact element 5 is shifted upwards by for example 12 mm in order to avoid an unfavorable mutual shadowing of contact elements 5 and 6 in the rotational position test. For this purpose, one of the above-described rotary grippers of the movable rotating module can be displaced upwards by 12 mm by a compressed air cylinder. The displacement is selected so that it enables the largest possible angular measurement range without shadowing while still being within the test range of the optical test unit 11. In the present case, the test area has a diameter of approximately 25 mm, as an example. Thanks to this offset, a new shadow image appears, which is now suitable for testing in the previous difficult area 55. The shift distorts the shadow curve, which is scanned by the testing unit of the detection apparatus 11. The minima previously located in an overlapping area exit from this area due to the distortion and can be detected.

The above-mentioned predetermined fixed value of 12 mm for the displacement path is aimed at an example that can occur for commonly used cable strands with twisted cables, such as those frequently used for cable harnesses for automobiles or aircraft. In one embodiment, the dimension of the displacement can be adjusted or adapted to the particular situation, so that the distorted shadow curve does not overlap the area of the minimum to be expected.

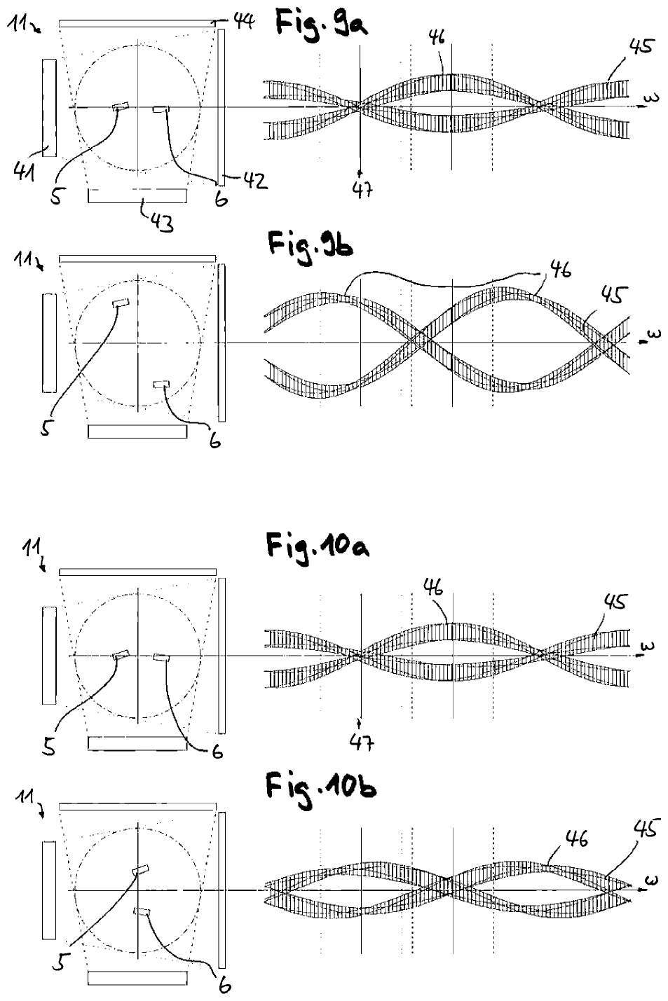

FIGS. 9a, 9b, and 10a, 10b show further variants of test situations in which the creation of an offset is advantageous. FIGS. 9b and 10b show situations with offset contact elements 5, 6 through displacement of the cable rotating modules.

FIGS. 9a and 9b here relate to a variant embodiment in which both rotating modules or their rotary grippers can be displaced in height in the vertical direction, wherein one rotary gripper is displaced upwards and the other rotary gripper is displaced downwards. Both shadow curves can thereby be distorted in order to further minimize the chances of a disadvantageous overlap. In this embodiment, the two cable axes are at the same z position (FIG. 8a) as the axis of rotation of the test head. The offset is adjusted accordingly (FIG. 9b).

FIGS. 10a and 10b relate to a variant embodiment in which the rotary grippers are displaced diagonally, so that the cable axes are one above the other in the z-direction. The diagonal direction is understood to be an oblique direction of displacement that is inclined by 45° to the horizontal, as in the present example. The contact elements 5, 6 can in this way be easily moved from the initial position, in which the contact elements 5, 6 lie on the same horizontal ordinate axis (FIG. 10a), to the position shown in FIG. 10b, in which the contact elements 5, 6 lie on the same vertical ordinate axis. Thus, in the case of contact elements 5, 6 with a horizontally flat cross-section, the rotary position test is substantially improved, since the smaller minima can hardly move into an overlapping area.

After completion of the alignment in the correct rotational position, the assembly gripping unit 12, comprising two individually controllable assembly cable grippers 30, 31, grips the cable ends at their respective z positions and the optical detection apparatus 11 is moved away from the test position. Before or during moving away, scanning of the contact elements 5, 6 is performed to determine the positions of the tips of the contact elements in a known manner. Then the assembly cable grippers 30, 31 insert the contact elements 5, 6 into the provided slots or cells on the plug housing, adapting the assembling procedure to the positions of the tips.

In another preferred embodiment of the alignment process, the contact elements can be fed to the cable alignment apparatus 10 in a pre-aligned manner. Thanks to this measure, the angular range by which the cable alignment apparatus 10 must be able to rotate the contact elements 5, 6 can be reduced to ±20°. The examination area of the test head 40 can also be reduced, since with pre-aligned contact elements 5, 6, one local minimum 46 per contact element is sufficient to determine the rotational position. In this manner, contact elements 5, 6 with an asymmetrical cross-section can also be easily processed.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A cable alignment apparatus for aligning assembled cable ends of two cables of a twisted cable strand in a predetermined correct rotational position, the cable alignment apparatus comprising:
two cable rotating modules each adapted to rotate a respective one of the assembled cable ends about a longitudinal axis of the respective assembled cable end;
wherein each of the cable rotating modules has a rotary cable gripper and a rotating apparatus that rotates the rotary cable gripper;
an apparatus frame that supports the cable rotating modules; and
wherein at least one of the cable rotating modules is displaceable by a drive relative to the apparatus frame.

2. The cable alignment apparatus according to claim 1 wherein the at least one of the cable rotating modules is displaceable in a vertical direction transverse to the longitudinal axis of the respective assembled cable end.

3. The cable alignment apparatus according to claim 1 wherein another of the cable rotating modules is arranged in a stationary position on the apparatus frame.

4. The cable alignment apparatus according to claim 1 wherein the two cable rotating modules are arranged one behind another in relation to a longitudinal direction parallel to a longitudinal axis of the cable strand.

5. The cable alignment apparatus according to claim 1 wherein the drive is a pneumatic cylinder integrated in the apparatus frame.

6. The cable alignment apparatus according to claim 1 wherein each of the rotating apparatuses includes a drive connected to the rotary cable gripper via a pinion and toothed ring segment.

7. The cable alignment apparatus according to claim 6 wherein each of the rotary cable grippers is attached to the toothed ring segment, the toothed ring segment limiting a rotational range of the rotary cable gripper to 90° or less.

8. The cable alignment apparatus according to claim 7 wherein the rotational range of the rotary cable gripper is between 30° and 45°.

9. A method for aligning assembled cable ends of two cables of a twisted cable strand in a predetermined correct rotational position using the cable alignment apparatus according to claim 1, the method comprising the steps of:
gripping each of the assembled cable ends with an associated one of the rotary cable grippers;
operating the cable alignment apparatus to bring the assembled cable ends to different heights thereby creating an offset between the assembled cable ends; and
changing a rotational position of at least one of the assembled cable ends by the cable alignment apparatus to align the respective assembled cable ends in the predetermined correct rotational position.

10. The method according to claim 9 including creating the offset by moving the assembled cable ends relative to one another by a predetermined or variable displacement path.

11. The method according to claim 10 including moving the assembled cable ends away from each other or towards each other in a diagonal direction until cable axes of the assembled cable ends are one above the other in a vertical direction.

12. The method according to claim 9 including, before creating the offset, determining a rotational position of each of the assembled cable ends by an optical detection apparatus, wherein the optical detection apparatus uses a shadow image of contact elements on the assembled cable ends for the rotational position detection.

13. The method according to claim 12 wherein the optical detection apparatus includes two light curtains with associated line sensors, the two light curtains being oriented at right angles to one another.

14. The method according to claim 9 wherein each of the rotary cable grippers is attached to an associated toothed ring segment that limits a rotation range of the rotary cable gripper, and wherein when a current rotational position of one of the assembled cable ends exceeds a predetermined angular range, the rotary cable gripper gripping the one assembled cable end is brought into an initial position that is remote from a neutral position predetermined by the toothed ring segment.

15. The method according to claim 9 including after finally aligning the assembled cable ends in the predetermined correct rotational position, and while the assembled cable ends are still held by the rotary cable grippers or after the assembled cable ends have been gripped by the assembly gripper unit, performing a rotary position end test.
